(19) United States
(12) Patent Application Publication
(10) Pub. No.: US 2017/0015366 A1
(43) Pub. Date: Jan. 19, 2017

(54) SURFACE ELEMENT FOR A CAMPING VEHICLE OR MOBILE HOME

(71) Applicant: Knaus Tabbert GmbH, Jandelsbrunn (DE)

(72) Inventors: Jürgen Thaler, Sonnen (DE); Kurt Wachtveitl, Thyrnau (DE)

(73) Assignee: Knaus Tabbert GmbH, Jandelsbrunn (DE)

(21) Appl. No.: 15/210,241

(22) Filed: Jul. 14, 2016

(30) Foreign Application Priority Data
Jul. 14, 2015 (DE) 102015111421.6

(51) Int. Cl. B62D 29/04; B62D 25/06; B62D 25/20; B62D 25/02

(52) U.S. Cl. CPC B62D 29/043; B62D 25/02; B62D 25/06; B62D 25/20

(57) ABSTRACT

The invention relates to a surface element, in particular a wall element, for a camping vehicle or a mobile home, in particular caravans, motorhomes, etc., as well as a method for its production.

### CROSS REFERENCE TO RELATED APPLICATION

This application claims benefit of Application No. 10 2015 111 421.6, filed on Jul. 14, 2015 in Germany and which application is incorporated herein by reference. A claim of priority is made.

### SUMMARY

The present invention relates to a surface element, in particular a wall element for a camping vehicle, in particular a caravan, motorhome, etc. Furthermore, the invention relates to a method for producing such a surface element.

The term “surface element” in the sense of the invention at hand comprises, for example, the side walls or sections of side walls of camping vehicles. Moreover, the term “surface element” can also refer to the roof or roof sections, the floor or floor sections as well as the rear wall or rear wall sections of a camping vehicle. The term “surface element”, however, is not restricted to the outer walls of a camping vehicle. In fact, it can also comprise inner walls or walls of pieces of furniture which are located inside a camping vehicle. Preferably, however, the surface element according to the invention is a side wall of a camping vehicle.

As a general rule, the surface elements for camping vehicles known from the state of the art comprise, besides elements made of metal or plastic, elements made of wood, for example wooden strips. The disadvantage of using wooden elements is in particular that wood changes its form and structure over time. For instance, wood can swell if it comes into contact with water or water vapor. Through the swelling of wooden strips, for example, which are required for the stabilization of surface elements, in particular side walls, the wooden strips expand, so that they might stand out against the outer shell of the camping vehicle. This leads to unaesthetic optics. Another disadvantage in using wood is that it can rot over time, losing its stabilizing function in the process. For the reasons outlined above, wooden elements, such as wooden strips, have been sought to be replaced more and more by using plastic elements, such as PU strips. This is complex and very costly. Moreover, both alternatives require a lot of storage space for the wooden and plastic elements.

The object of the invention at hand is to provide a surface element and a method for producing a surface element, respectively, which overcome the disadvantages of the state of the art. In particular, the object of the invention was to provide a surface element which is simple and cheap to produce, can manage without lose elements as well as shows a better quality (for example a smoother surface and/or improved static).

The object is attained by a surface element of the kind mentioned above, comprising a frame structure which is molded from of a hardenable material dispensable from a dispensing device, further comprising two top layers connected with the frame structure between which the frame structure is arranged, as well as insulating material which at least partially fills the spaces of the frame structure and is arranged between the top layers as well.

The object mentioned above underlying the invention is moreover attained by a method for producing surface elements for a camping vehicle or mobile home, comprising the following steps:

a) producing a frame structure by applying a flowable, hardenable material in a desired form onto a base;
b) hardening of the flowable, hardenable material;
c) connecting of the finished frame structure with at least one top layer.

Flowable material comprises in particular paste-like or viscous material with high viscosity. As a general rule, the dispensable material of the frame structure is applied to a base from a dispensing device during the production of a surface element according to the invention. This is usually carried out by a casting process.

The surface elements according to the invention and the surface elements produced with the method according to the invention, respectively, have several advantages compared to surface elements from the state of the art. The surface elements according to the invention can be completely free of wooden elements, in particular wooden strips. By means of the method according to the invention, a frame structure can be produced which only has structures, such as strips, made of the same material. Of course, the individual elements of the frame structure can also be produced from different materials, material thicknesses, etc. Another advantage of the method according to the invention as well as the surface element according to the invention is that any geometry of the frame structure is possible. Moreover, a form closure and adhesive bond are possible during production of the frame structure. Certain areas can be reinforced in a simple way by applying more material to areas requiring reinforcing. These areas can serve, for example, for accommodating fixing elements, such as screws. Small metal sheets or other structures are often used in the surface elements in the state of the art.

Another great advantage is that the pre-production and storing of certain frame structure elements, for example strips, are eliminated in the method according to the invention. As a general rule in the method according to the invention, the application of the flowable, hardenable material is carried out with the help of a dispensing device whose actions (for example dispensing rate, movement in a space, etc.) can be controlled automatically as a general rule. Due to these automatic processes, manual activities can be substituted completely. Due to the fact that wooden elements, in particular wooden strips, are entirely unnecessary, surface elements having an entirely flat, optically aesthetic surface can be produced by means of the method according to the invention.

For stabilization, individual connecting structures can be produced in required breadths as well as with possibly different materials/densities. Partial areas (lift bed screw connections) can be produced with separate materials (for example reinforced with fiber, higher densities). Furthermore, the method according to the invention and the surface element according to the invention, respectively, enable a weight reduction of the vehicle by optimizing the cross-sections.

The material of the frame structure is preferably one from the group of plastic, fiber-reinforced plastic, natural-fiber-reinforced plastic, for example bamboo-reinforced plastic or plastic reinforced by rice husks, resin, foam, for example PU foam. These materials have particularly advantageous physical attributes and are particularly suitable for the production of a frame structure of a surface element according to the invention, for example in a casting process.

In a possible embodiment of the surface element according to the invention, the insulating material is plate-shaped, wherein it is preferably made of EPS or XPS. In materials science, EPS is understood to be expanded polystyrene, whereas XPS is understood to be extruded polystyrene.

In another embodiment of a surface element according to the invention, the insulating material is flowable. This means it can be available in the form of polystyrene beads as a filling material or polyurethane foam.

The top layers of the surface element according to the invention can be made of sheet metal, plastic or natural fiber materials, for example. Some of the preferred embodiments of the method according to the invention are described subsequently.

In one of the preferred embodiments of the method according to the invention, the desired form of the frame structure is introduced, in particular incised or milled, into a panel of insulating material, in particular insulating material made of EPS, XPS or similar, wherein the panel is subsequently connected with a top layer, and then the flowable, hardenable material is introduced into the incised spaces in the panel for producing the frame structure. The insulating material has two functions in this embodiment of the method. On the one hand, it isolates, on the other hand, it forms a receiving mold for the frame structure material.

In another preferred embodiment, the flowable, hardenable material is applied, in particular in an NC controlled manner, onto one of two top layers for producing the frame structure. Subsequently, flowable insulating material is introduced into the spaces of the frame structure and then the second top layer is applied, in particular glued, to the frame structure, so that the frame structure and the insulating material is arranged between the two top layers. The flowable insulating material can be automatically introduced into spaces of the frame structure, for example. The advantage of this embodiment is that the insulating material need only be introduced in certain places.

In another embodiment of the method according to the invention, the flowable, hardenable material is applied, in particular in an NC-controlled manner, on to a work base for producing the frame structure, wherein the frame structure is subsequently connected, in particular glued together, with a top layer, and flowable insulating material is subsequently introduced into spaces of the frame structure, and then the second top layer is applied, in particular glued, onto the frame structure, so that the frame structure and the insulating material are arranged between the two top layers.

As a general rule, the flowable, hardenable material is applied via a casting process.

In a further development of the method according to the invention, the frame structure is produced in at least two work steps, wherein different materials and/or material thicknesses are preferably used for different frame structure sections in the corresponding work steps. This initially enables the production of a base frame structure formed in one piece, for example. Details can be incorporated in a second work step.

Preferably, after the application of the second top layer on the frame structure, the entire sandwich-like structure is further processed by milling out window and door areas, in particular, and/or incorporating an outer contour. Thus, either an entirely flat surface element or a curved surface element can be produced, for example.

Preferably, the flowable, hardenable material is one from the group of plastic, fiber-reinforced plastic, natural-fiber-reinforced plastic, for example bamboo-reinforced plastic or plastic reinforced by rice husks, resin, foam, for example PU foam.

As a general rule before applying the second top layer, the surface of the composite structure made of the frame structure and the insulating material is calibrated, for example smoothed, machine-processed, or the like. In this way, a level composite structure can be formed.

Other features of the invention can be gathered from the following description of preferred embodiment examples of the invention in connection with the drawings and the dependent claims. The individual characteristics can be realized alone or in combination with each other.

### DESCRIPTION OF FIGURES

In the figures:

FIG. 1: shows the schematic procedure of a first embodiment of the method according to the invention for producing a surface element according to the invention;

FIG. 2: shows the schematic procedure of a second embodiment of the method according to the invention for producing a surface element according to the invention;

FIG. 3: shows the schematic procedure of a third embodiment of the method according to the invention for producing a surface element according to the invention;

FIG. 4: shows a top view of a frame structure of a surface element according to the invention.

### DETAILED DESCRIPTION

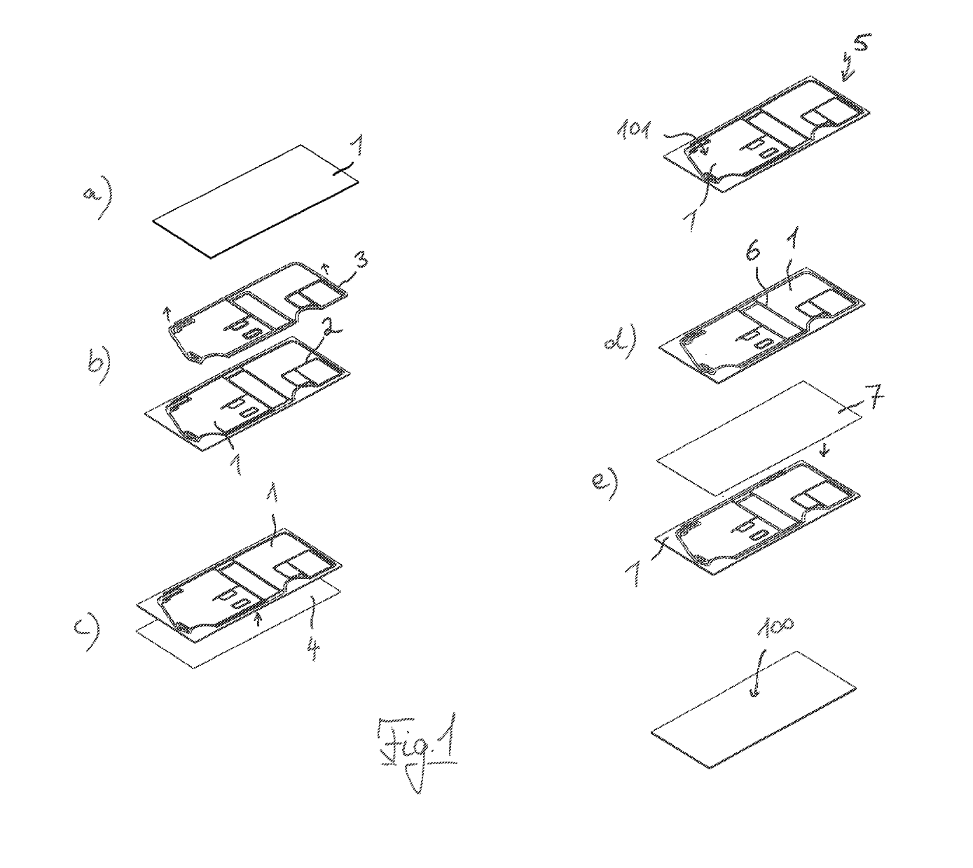

FIG. 1 schematically shows the approach to an embodiment of the method according to the invention. In this embodiment, a large-sized panel 1 is initially produced from EPS or XPS (step a)). Now, the desired contours 2 of a frame structure are incised or milled out of the panel 1. The parts 3 not required are removed (step b)). Now a top layer 4 is glued thereon (step c)). The top layer 4 corresponds to the later outer shell or inner shell of a side wall of a camping vehicle in the case at hand. The composite structure 5 made of the top layer 4 and the incised panel 1 functions as a stencil 101 for the frame structure to be produced in the next step. Here, the hollow spaces 2 in the panel 1 are filled with flowable plastic (step d)). After the hardening of the plastic, the finished frame structure 6 is available. Now, the open surface is calibrated. Then, a second top layer 7 is glued thereon (step e)). This second top layer 7 later functions as an inner shell or outer shell of a side wall of a camping vehicle. After gluing on the second top layer, a finished sandwich-like composite is now available which corresponds to a surface element according to the invention in form of a wall element 100. This sandwich-like composite can now be processed further (for example by milling out windows and/or doors, incorporating an outer contour, etc.).

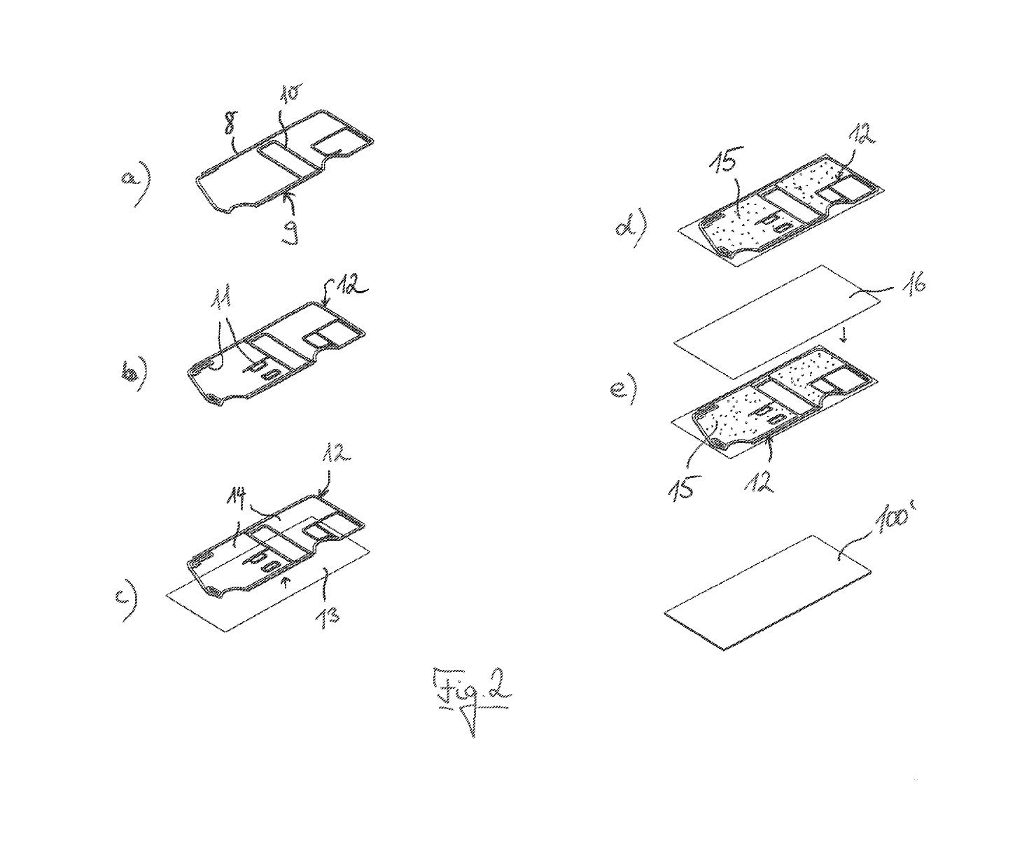

FIG. 2 schematically shows the procedure of another embodiment of the method. In this embodiment, flowable material 8 is initially applied in a desired form onto a work table from a dispensing device, so that a base frame structure 9 is initially formed. This base frame structure 9 already has a contour 10 for a door, for example (step a)).

Subsequently, additional structures 11 are applied onto the work table. The additional structures consist of a different flowable, hardenable material in this case. Polyurethane foam was used for the additional structures 11 in this case. Ultimately, a finished frame structure 12 is available (step b)).

Now, a top layer 13 is glued together with the frame structure 12 (step c)). Now, flowable insulating material 15 is introduced into the spaces 14 of the frame structure 12 (step d)). After the hardening of the frame structure 12, the open surface is calibrated. In the next step, a second top layer 16 is glued onto the frame structure 12.

Ultimately, another finished sandwich-like composite is available here, too, which corresponds to a surface element 100′ according to the invention and can be processed further.

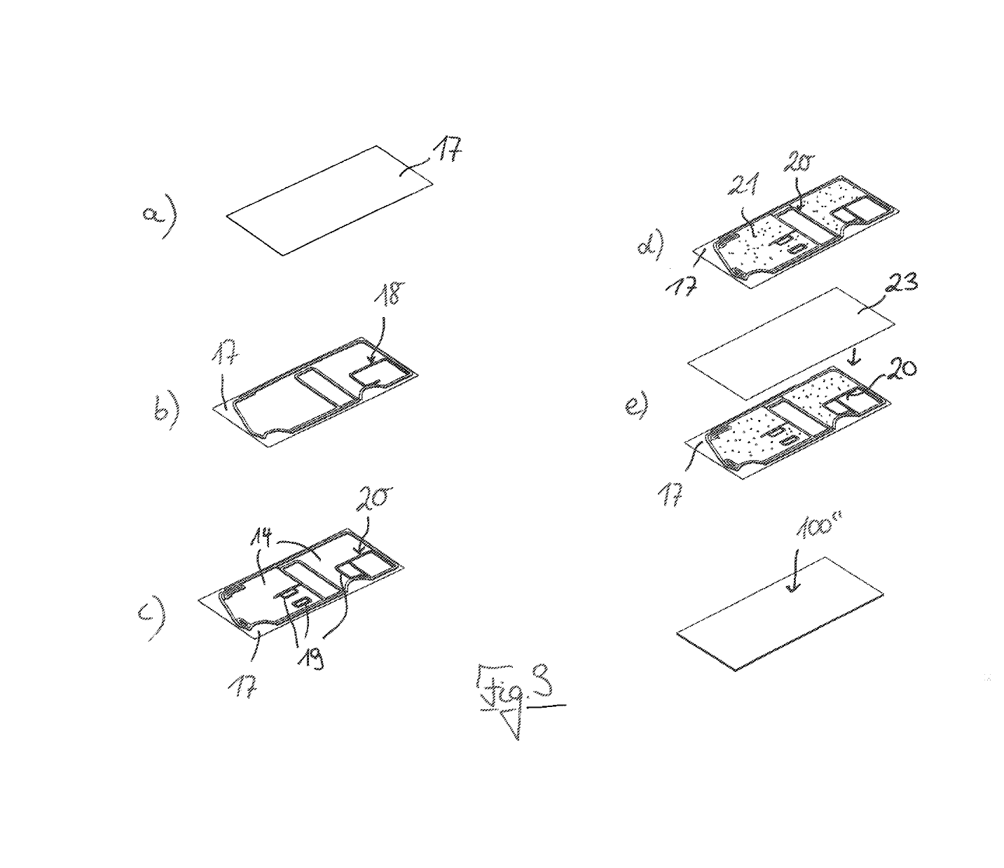

FIG. 3 shows a schematic illustration of the procedure of a third embodiment of the method. In this embodiment, one of two top layers 17 is initially fixed on a work surface and optionally adhered thereto via a vacuum (step a)).

Now, a base frame structure 18 is applied onto the top layer 17 via a dispensing device (step b)).

In another step of the method, additional structures 19 are applied to the top layer 17 (step c)). Ultimately, a finished frame structure 20 is available.

Now insulating material 21 is introduced into the spaces 14 of the finished frame structure 20 (step d)). The insulating material 21, however, is not introduced into door and window openings 22. After the hardening of the frame structure material, the surface is calibrated.

Now a second top layer 23 is glued onto the frame structure 20 (step e)). Ultimately, a finished sandwich composite is available which corresponds to a surface element 100″ according to the invention. This sandwich composite can now be processed further (for example milling for windows and doors, outer contour).

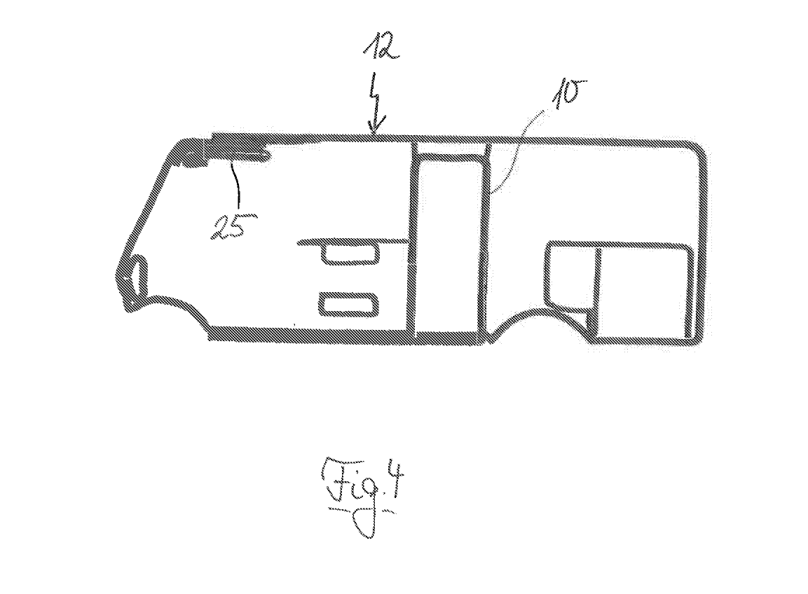

FIG. 4 shows the frame structure 12 of the surface element produced in embodiment 2 of the method (FIG. 2). The frame structure 12 comprises a door section 10. The corners of the door section are not filled with stiffening corners, since the corners were sprayed following the contour of the door. The frame structure shown here is intended for use as a side wall of a camping vehicle in which a lift bed is to be arranged in the frontal upper area. In this area, a reinforcement of the frame structure 12 can be observed in the frame structure 12 in which several layers 25 of frame structure material are arranged over each other. Due to the layers 25, a good screwing possibility is provided for a lift bed.

1-6. (canceled)

7. A method for producing a surface element for a camping vehicle or a mobile home,
comprising the following steps:
a) producing a frame structure by applying a flowable, hardenable material in a desired form onto a base;
b) hardening the flowable, hardenable material;
c) connecting the finished frame structure with at least one top layer.

8. The method according to claim 7, wherein the desired form of the frame structure is introduced into a panel made of insulating material, the panel is subsequently connected with a top layer and then the flowable, hardenable material is introduced, into the incised spaces in the panel in order to produce a frame structure.

9. The method according to claim 7, wherein the flowable, hardenable material is sprayed, onto one of two top layers for producing the frame structure, flowable insulating material, is subsequently introduced into spaces of the frame structure, and then the second top layer is glued, onto the frame structure, so that the frame structure and the insulating material are arranged between the two top layers.

10. The method according to claim 7, wherein the flowable, hardenable material is applied onto a work base for producing the frame structure, subsequently the frame structure is connected, with a top layer, flowable insulating material, is subsequently introduced into spaces of the frame structure, and then the second top layer is applied onto the frame structure so that the frame structure and the insulating material are arranged between the two top layers.

11. The method according to claim 7, wherein the flowable, hardenable material is introduced or applied, respectively, via a casting process.

12. The method according to claim 7, wherein the frame structure is produced in at least two work steps, wherein different materials and/or different material thicknesses are preferably used for different frame structure sections in the corresponding work steps.

13. The method according to claim 7, wherein after the application of the second top layer onto the frame structure, the sandwich-like structure, consisting of two top layers, a frame structure and insulating material, is further processed by milling out window and door areas and/or incorporating an outer contour.

14. The method according to claim 7, wherein the flowable, hardenable material is one or more of plastic, fiber-reinforced plastic, natural-fiber-reinforced plastic, resin, and foam.

15. The method according to claim 7, wherein before applying the second top layer, the surface of the composite structure consisting of a frame structure and insulating material is calibrated, for example smoothed, machine-processed, etc.

16-20. (canceled)
